(19) United States
(12) Patent Application Publication
(10) Pub. No.: US 2026/0095922 A1
(43) Pub. Date: Apr. 2, 2026

(54) METHOD AND APPARATUS FOR CHANNEL MEASUREMENT FOR A SIDELINK UNLICENSED SPECTRUM

(71) Applicant: LENOVO (BEIJING) LIMITED, Beijing (CN)

(72) Inventors: Xiaodong YU, Beijing (CN); Haipeng LEI, Beijing (CN); Zhennian SUN, Beijing (CN); Xin GUO, Beijing (CN)

(21) Appl. No.: 19/110,755

(22) PCT Filed: Sep. 29, 2022
(86) PCT No.: PCT/CN2022/122619

§ 371 Date: Mar. 11, 2025

(51) Int. Cl. H04W 72/25; H04B 17/318; H04W 72/044

(52) U.S. Cl. CPC H04W 72/25; H04B 17/328; H04W 72/044

(57) ABSTRACT

Embodiments of the present disclosure relate to methods and apparatuses for channel measurement for a sidelink unlicensed spectrum (SL-U). According to some embodiments of the disclosure, a user equipment (UE) may include a transceiver; and a processor coupled to the transceiver. The processor may be configured to receive, via the transceiver, at least one of: a configuration from a network node, wherein the configuration includes a threshold related to linear average of total received power within a time unit, and wherein the time unit is one of: a slot, a mini-slot, and a sub-slot; a sidelink control information (SCI) transmission within the time unit on a sidelink on an unlicensed band; or a sequence transmission within the time unit on the sidelink on the unlicensed band; and determine whether to observe a sidelink received signal strength indicator (SL RSSI) within the time unit for the sidelink on the unlicensed band.

### TECHNICAL FIELD

Embodiments of the present disclosure generally relate to wireless communication technology, especially to methods and apparatuses for channel measurement for a sidelink unlicensed spectrum (SL-U).

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In the above wireless communication systems, a user equipment (UE) may communicate with another UE via a data path supported by an operator's network, e.g., a cellular or a Wi-Fi network infrastructure. The data path supported by the operator's network may include a base station (BS) and multiple gateways.

Some wireless communication systems may support sidelink communications, in which devices (e.g., UEs) that are relatively close to each other may communicate with one another directly via a sidelink, rather than being linked through the BS. The term “sidelink” may refer to a radio link established for communicating among devices (e.g., UEs), as opposed to communicating via the cellular infrastructure (e.g., uplink and downlink). Sidelink transmission may be performed on a licensed spectrum and an unlicensed spectrum. An unlicensed spectrum may also be named as an unlicensed band or the like.

Currently, details regarding channel measurement for SL-U have not been discussed yet.

### SUMMARY

Some embodiments of the present disclosure provide a user equipment (UE). The UE may include a transceiver; and a processor coupled to the transceiver. The processor may be configured to receive, via the transceiver, at least one of: a configuration from a network node, wherein the configuration includes a first threshold related to linear average of total received power within a time unit, and wherein the time unit is one of: a slot, a mini-slot, and a sub-slot; a sidelink control information (SCI) transmission within the time unit on a sidelink on an unlicensed band; or a sequence transmission within the time unit on the sidelink on the unlicensed band; and determine whether to observe a sidelink received signal strength indicator (SL RSSI) within the time unit for the sidelink on the unlicensed band.

In some embodiments, the processor of the UE is configured to: measure first linear average of total received power observed in a first frequency domain resource and a first time domain resource within the time unit; measure second linear average of total received power observed in the first frequency domain resource and a second time domain resource within the time unit; determine whether a difference between the first linear average of total received power and the second linear average of total received power is equal to or less than the first threshold; and in response to the difference being equal to or less than the first threshold, determine to observe the SL RSSI within the time unit.

In some embodiments, the first threshold is of a fixed value, a configured value, or a pre-configured value.

In some embodiments, the first threshold is configured or pre-configured per sub carrier spacing (SCS) or per a resource pool.

In some embodiments, in response to determining to observe the SL RSSI, the processor of the UE is configured to determine third linear average of total received power within the time unit as the SL RSSI to be of one of: the first linear average of total received power; the second linear average of total received power; linear average of both the first linear average of total received power and the second linear average of total received power; and linear average of total received power within the time unit.

In some embodiments, the first time domain resource includes one or more symbols after a starting symbol of the time unit and before the second time domain resource within the time unit; and the second time domain resource includes one or more symbols after the first time domain resource and before an ending symbol of the time unit.

In some embodiments, the processor of the UE is configured to: determine whether at least one of a sidelink control information (SCI) transmission or a sequence transmission is transmitted within the time unit; and in response to detecting the at least one of the SCI transmission or the sequence transmission transmitted within the time unit, determine to observe the SL RSSI within the time unit.

In some embodiments, in response to determining to observe the SL RSSI, the processor of the UE is configured to measure third linear average of total received power in a first frequency domain resource within the time unit as the SL RSSI.

In some embodiments, the first frequency domain resource includes at least one of: one or more sub-channels; one or more interlaces; one or more resource block (RB) sets; or a measurement bandwidth.

In some embodiments, at least one of the first linear average of total received power, the second linear average of total received power, or the third linear average of total received power is measured starting from: a symbol after a starting symbol of the time unit; or a configured starting point after the starting symbol of the time unit.

In some embodiments, the configuration includes at least one of: a second threshold related to linear average of total received power sensed per time unit over a channel busy ratio (CBR) measurement window for the sidelink on the unlicensed band; a default value of a sidelink CBR measurement value for the sidelink on the unlicensed band; or a minimum total number of RSSI measurement time units for the sidelink on the unlicensed band.

In some embodiments, to determine whether to observe the SL RSSI, the processor of the UE is configured to: receive information regarding wireless local area network (WLAN) RSSI measurement time units within a channel busy ratio (CBR) measurement window; and determine whether there is a SL RSSI measurement time unit by excluding the WLAN RSSI measurement time units from RSSI measurement time units within the CBR measurement window.

In some embodiments, the processor of the UE is configured to: determine whether a total number of SL RSSI measurement time units within the CBR measurement window is less than the minimum total number, wherein linear average of total received power of a SL RSSI within each of the SL RSSI measurement time units exceeds the second threshold; and in response to the total number is less than the minimum total number, set the total number as the default value.

Some embodiments of the present application also provide a network node (e.g., a base station (BS)). The network node includes a transceiver; and a processor coupled to the transceiver. The processor may be configured to transmit a configuration configured for a sidelink on an unlicensed band via the transceiver to a user equipment (UE), wherein: the configuration includes a first threshold related to linear average of total received power within a time unit; the time unit is one of: a slot, a mini-slot, and a sub-slot; and in response to a difference between a first linear average of total received power observed in a first frequency domain resource and a first time domain resource within the time unit and a second linear average of total received power observed in the first frequency domain resource and a second time domain resource within the time unit being equal to or less than the first threshold, the SL RSSI is determined by the UE to be observed within the time unit.

In some embodiments, the first threshold is of a fixed value, a configured value, or a pre-configured value.

In some embodiments, the first threshold is configured or pre-configured per sub carrier spacing (SCS) or per a resource pool.

In some embodiments, the first frequency domain resource includes at least one of: one or more sub-channels; one or more interlaces; one or more resource block (RB) sets; or a measurement bandwidth.

In some embodiments, the first time domain resource includes one or more symbols after a starting symbol of the time unit and before the second time domain resource within the time unit; and the second time domain resource includes one or more symbols after the first time domain resource and before an ending symbol of the time unit.

In some embodiments, the configuration includes at least one of: a second threshold related to linear average of total received power sensed per time unit over a channel busy ratio (CBR) measurement window for the sidelink on the unlicensed band; a default value of a sidelink CBR measurement value for the sidelink on the unlicensed band; or a minimum total number of RSSI measurement time units for the sidelink on the unlicensed band.

In some embodiments, in response to a total number of SL RSSI measurement time units within the CBR measurement window being less than the minimum total number, the total number is set by the UE as the default value.

Some embodiments of the present disclosure provide a method performed by a user equipment (UE). The method may include: receiving at least one of: a configuration from a network node, wherein the configuration includes a first threshold related to linear average of total received power within a time unit, and wherein the time unit is one of: a slot, a mini-slot, and a sub-slot; a sidelink control information (SCI) transmission within the time unit on a sidelink on an unlicensed band; or a sequence transmission within the time unit on the sidelink on the unlicensed band; and determining whether to observe a sidelink received signal strength indicator (SL RSSI) within the time unit for the sidelink on the unlicensed band.

Some embodiments of the present disclosure provide a method performed by a network node (e.g., a BS). The method may include transmitting a configuration configured for a sidelink on an unlicensed band to a user equipment (UE), wherein: the configuration includes a first threshold related to linear average of total received power within a time unit; the time unit is one of: a slot, a mini-slot, and a sub-slot; and in response to a difference between a first linear average of total received power observed in a first frequency domain resource and a first time domain resource within the time unit and a second linear average of total received power observed in the first frequency domain resource and a second time domain resource within the time unit being equal to or less than the first threshold, the SL RSSI is determined by the UE to be observed within the time unit.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method performed by a UE or a network node (e.g., a base station (BS)) according to some embodiments of the present disclosure.

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure.

FIG. 2 illustrates a flowchart of an exemplary procedure related to a SL RSSI over an unlicensed spectrum in accordance with some embodiments of the present disclosure.

FIG. 3 illustrates an exemplary diagram of SL RSSI measurement in a CBR measurement window in accordance with some embodiments of the present disclosure.

FIG. 4 illustrates an exemplary flowchart of SL RSSI measurement in accordance with some embodiments of the present disclosure.

FIG. 5 illustrates another exemplary flowchart of SL RSSI measurement in accordance with some embodiments of the present disclosure.

FIG. 6 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

FIG. 1 illustrates a schematic diagram of a wireless communication system in accordance with some embodiments of the present disclosure.

As shown in FIG. 1, a wireless communication system 100 may include a base station (e.g., BS 120) and some UEs 110 (e.g., UE 110a, UE 110b, and UE 110c). Although a specific number of UEs 110 and one BS 120 are depicted in FIG. 1, it is contemplated that any number of BSs and UEs in and outside of the coverage of the BSs may be included in the wireless communication system 100.

In some embodiments of the present disclosure, BS 120 may be referred to as an access point, an access terminal, a base, a base unit, a macro cell, a Node-B, an evolved Node B (eNB), a gNB, a Home Node-B, a relay node, or a device, or described using other terminology used in the art. BS 120 is generally a part of a radio access network that may include one or more controllers communicably coupled to one or more corresponding BSs. BS 120 may communicate with UE(s) 110 via downlink (DL) communication signals.

UE(s) 110 (e.g., UE 110a, UE 110b, or UE 110c) may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, UE(s) 110 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, UE(s) 110 includes wearable devices, such as smart watches, fitness bands, optical head-mounted displays, or the like. Moreover, UE(s) 110 may be referred to as a subscriber unit, a mobile, a mobile station, a user, a terminal, a mobile terminal, a wireless terminal, a fixed terminal, a subscriber station, a user terminal, an IoT device, a vehicle, or a device, or described using other terminology used in the art. UE(s) 110 may communicate with BS 120 via uplink (UL) communication signals.

Wireless communication system 100 may be compatible with any type of network that is capable of sending and receiving wireless communication signals. For example, wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, wireless communication system 100 is compatible with 5G NR of the 3GPP protocol. For example, BS 120 may transmit data using an orthogonal frequency division multiple (OFDM) modulation scheme on the DL and UE(s) 110 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, BS 120 and UE(s) 110 may communicate using other communication protocols, such as the IEEE 802.11 family of wireless communication protocols. Further, in some embodiments of the present disclosure, BS 120 and UE(s) 110 may communicate over licensed spectrums, whereas in some other embodiments, BS 120 and UE(s) 110 may communicate over unlicensed spectrums. The present disclosure is not intended to be limited to the implementation of any particular wireless communication system architecture or protocol.

BS 120 may define one or more cells, and each cell may have a coverage area 130. In the exemplary wireless communication system 100, some UEs (e.g., UE 110a and UE 110b) are within the coverage of BS 120, which may not be the specific BS 120 as shown in FIG. 1 and can be any one of the BSs 120 in a wireless communication system, and some UEs (e.g., UE 110c) are outside of the coverage of BS 120. For example, in the case that the wireless communication system includes two BSs 120 with UE 110a being within the coverage of any one of the two BSs means that UE 110a is within the coverage of a BS 120 (i.e., in-coverage) in the wireless communication system; and UE 110a being outside of the coverage of both BSs 120 means that UE 110a is outside the coverage of a BS 120 (i.e., out-of-coverage) in the wireless communication system.

Still referring to FIG. 1, UE 110a and UE 110b may communicate with BS 120 via, for example, a Uu link (denoted by dotted arrow in FIG. 1). UE 110a, UE 110b, and UE 110c may communicate with each other via a sidelink (denoted by solid arrow in FIG. 1).

Sidelink transmission may involve a physical sidelink control channel (PSCCH) and an associated physical sidelink shared channel (PSSCH), which may be scheduled by the sidelink control information (SCI) carried on the PSCCH. The SCI and associated PSSCH may be transmitted from a transmitting UE (hereinafter referred to as “Tx UE”) to a receiving UE (hereinafter referred to as “Rx UE”) in a unicast manner, to a group of Rx UEs in a groupcast manner, or to Rx UEs within a range in a broadcast manner. For example, referring to FIG. 1, UE 110a (acting as a Tx UE) may transmit data to UE 110b or UE 110c (acting as an Rx UE).

As specified in 3GPP TS 38.215, the IEEE 802.11 WLAN RSSI as used in RRC specification [10] refers to RSSI as defined in IEEE 802.11 specification [11], measured from Beacon, DMG Beacon or FILS discovery frames (in passive scanning mode) or from probe response frames (in active scanning mode). Received Signal Strength Indicator (RSSI) comprises the linear average of the total received power (in [W]) observed only per configured OFDM symbol and in the measurement bandwidth indicated by higher layers or corresponding to the channel bandwidth defined in Clause 4 of TS 37.213 [17], where the channel has the center frequency configured by ARFCN-valueNR, by the UE from all sources, including co-channel serving and non-serving cells, adjacent channel interference, thermal noise etc. [W] means “watt”, which is a unit of power.

As specified in 3GPP TS 38.215, sidelink received signal strength indicator (SL RSSI) is defined as the linear average of the total received power (in [W]) observed in the configured sub-channel in OFDM symbols of a slot configured for PSCCH and PSSCH, starting from the 2^{nd} OFDM symbol.

Sidelink Channel Occupancy Ratio (SL CR) is evaluated at slot n is defined as the total number of sub-channels used for its transmissions in slots [n-a, n-1] and granted in slots [n, n+b] divided by the total number of configured sub-channels in the transmission pool over [n-a, n+b]. SL CR is evaluated for each (re)transmission.

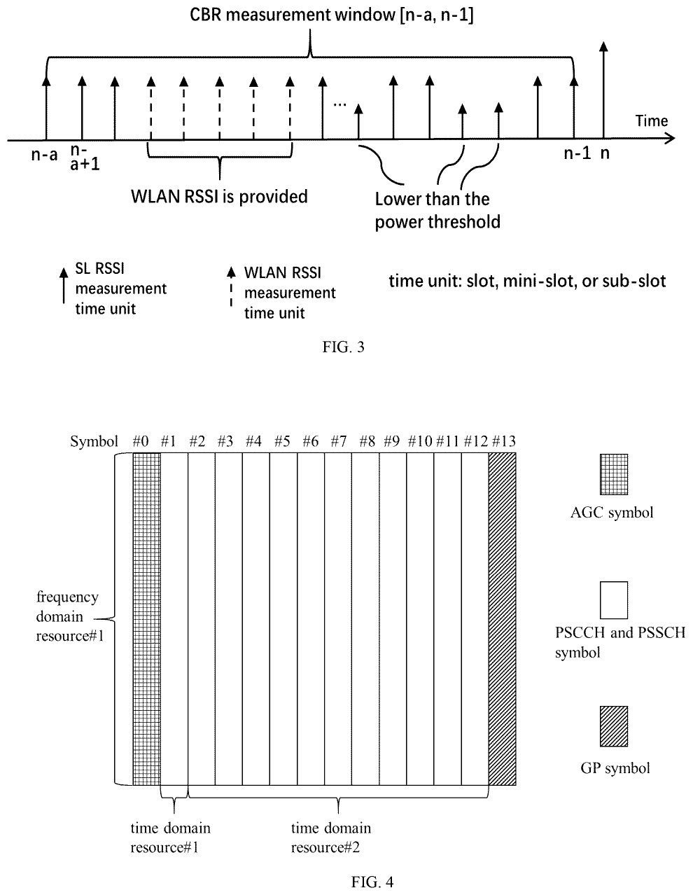

SL Channel Busy Ratio (SL CBR) measured in slot n is defined as the portion of sub-channels in the resource pool whose SL RSSI measured by the UE exceed a (pre-)configured threshold sensed over a CBR measurement window [n-a, n-1] (e.g., as shown in FIG. 3), wherein a is equal to 100 or 100·2^{μ} slots, according to higher layer parameter sl-Time WindowSizeCBR. When a UE is configured to perform partial sensing by higher layers (including when SL DRX is configured), SL RSSI is measured in slots where the UE performs partial sensing and where the UE performs PSCCH or PSSCH reception within the CBR measurement window. The calculation of SL CBR is limited within the slots for which the SL RSSI is measured. If the number of SL RSSI measurement slots within the CBR measurement window is below a (pre-)configured threshold, a (pre-)configured SL CBR value is used.

Based on legacy SL RSSI definition in TS 38.215, SL RSSI is defined as the linear average of the total received power (in [W]) observed in the configured sub-channel in OFDM symbols of a slot configured for PSCCH and PSSCH, starting from the 2^{nd} OFDM symbol. That is because, the measurement UE assumes only 3GPP system transmission is performed on sidelink, i.e., linear average of the total received power is not generated by the other system or radio access technology (RAT). And the effective PSCCH and PSSCH transmission is performed from the 2^{nd} OFDM symbol of a slot (here, the 1^{st} OFDM symbol of a slot is AGC symbol). Based on the above, following issues need to be addressed:
(1) In SL-U scenario, the potential sidelink transmission is not only from the 3GPP system, e.g., a vehicle UE or a commercial UE, but may be also from other system or other RAT, e.g., WLAN AP. I.e., the linear average of the total received power for SL RSSI measurement may also include the power transmitted from, e.g., WiFi node. So legacy SL RSSI definition cannot distinguish 3GPP and the other system or RAT, it may have impact on some sidelink mechanism, e.g., CBR reporting and related scheduling or configuring in Mode 1 and congestion control in Mode 2.
(2) If supported, legacy SL RSSI measurement starting from the 2^{nd} OFDM symbol (to the end of PSCCH and PSSCH transmission, e.g., 13^{th} OFDM symbol, here, 14^{th} OFDM symbol is GP symbol) within a slot may be not reasonable. Example, if the potential SL-U transmission is starting from 7^{th} OFDM symbol (7^{th} OFDM symbol is the AGC symbol for the PSCCH and PSSCH transmission, the PSCCH and PSSCH transmission is starting from 7^{th} OFDM symbol to 13^{th} OFDM symbol, and 14^{th} OFDM symbol is GP symbol), the SL RSSI measurement starting from the 2^{nd} OFDM symbol is inaccurate.

Given the above, the legacy SL RSSI measurement definition needs to be enhanced. Embodiments of the present disclosure provide solutions to solve the above issues. For example, some embodiments of the present disclosure define SL RSSI measurement for SL-U, to distinguish the SL RSSI between 3GPP and other system or RAT. Some embodiments of the present disclosure enhance the definition of SL RSSI for the structure of multiple starting points within a slot. Some embodiments of the present disclosure define a default value of SL CBR measurement value (if the total number of SL RSSI measurement slots within the CBR measurement window is below a (pre-)configured threshold) and a threshold for a minimum number of SL RSSI measurement slots. In the embodiments of the present disclosure, sidelink transmission(a) may be performed on an unlicensed spectrum. More details on the embodiments of the present disclosure will be illustrated in the following text in combination with the appended drawings.

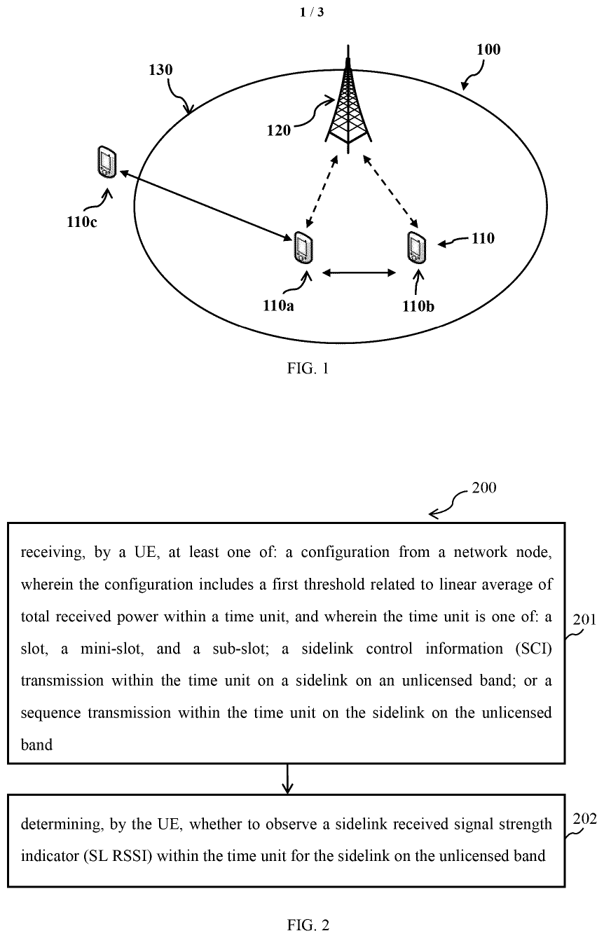

FIG. 2 illustrates a flowchart of an exemplary procedure related to a SL RSSI over an unlicensed spectrum in accordance with some embodiments of the present disclosure. The exemplary procedure 200 may be performed by a UE, for example, UE 110 in FIG. 1. In some embodiments, the exemplary procedure 200 may be performed by an Rx UE over sidelink. Although described with respect to a UE or an Rx UE, it should be understood that other devices may be configured to perform a method similar to that of FIG. 2.

Referring to FIG. 2, in operation 201, a UE (e.g., UE 110a in FIG. 1 or UE1 in FIGS. 2A and 2B) may receive at least one of:
(1) A configuration from a network node (e.g., BS 101 as shown in FIG. 1). The configuration is denoted as configuration#1 for simplicity. Configuration#1 may include a threshold (denoted as threshold#1) related to linear average of total received power within a time unit. The time unit may be one of: a slot, a mini-slot, and a sub-slot. Threshold#1 may be of a fixed value, a configured value, or a pre-configured value. In some embodiments, threshold #1 is (pre-)configured per SCS and/or per a resource pool.
(2) A SCI transmission within the time unit on a sidelink on an unlicensed band.
(3) A sequence transmission within the time unit on the sidelink on the unlicensed band.

In operation 202, the UE may determine whether to observe a SL RSSI within the time unit for the sidelink on the unlicensed band.

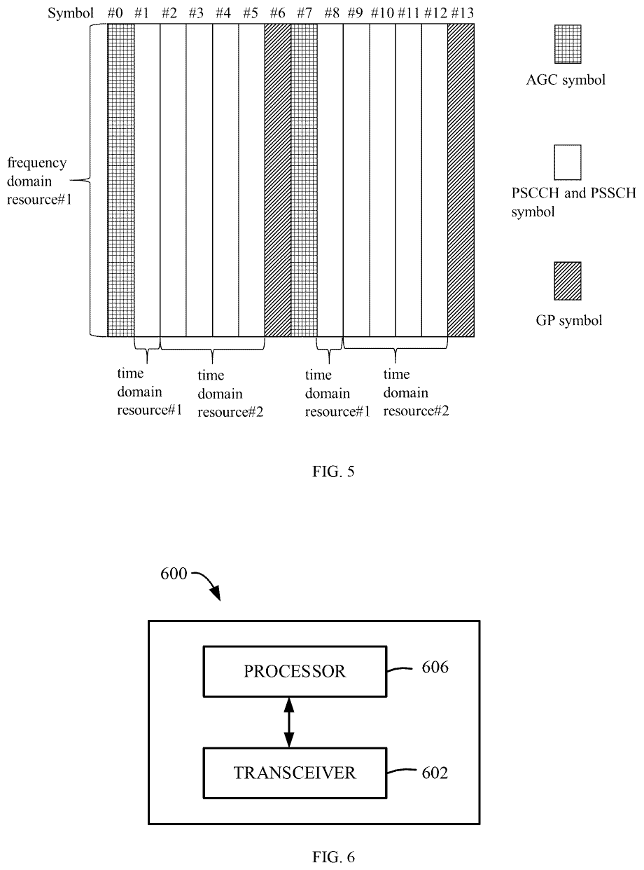

In some embodiments, the UE may measure linear average of total received power (denoted as linear average#1) which is observed in a frequency domain resource (denoted as frequency domain resource#1) and a time domain resource (denoted as time domain resource#1) within the time unit. The UE may measure a further linear average of total received power (denoted as linear average#2) which is observed in frequency domain resource#1 and a further time domain resource (denoted as time domain resource#2) within the time unit. Specific examples are described in the embodiments of FIGS. 4 and 5 as follows.

In an embodiment, linear average#1 and/or linear average#2 may be measured starting from “a symbol after a starting symbol of the time unit” or “a configured starting point after the starting symbol of the time unit”.

In an embodiment, time domain resource#1 includes one or more symbols after a starting symbol of the time unit and before time domain resource#2 within the time unit. Time domain resource#2 includes one or more symbols after time domain resource#1 and before an ending symbol of the time unit.

In an embodiment, frequency domain resource#1 may include at least one of: one or more sub-channels; one or more interlaces; one or more RB sets; or a measurement bandwidth.

In some embodiments, after measuring linear average#1 and linear average#2, the UE may determine whether a difference between linear average#1 and linear average#2 is equal to or less than threshold#1. In response to that the difference is equal to or less than threshold#1, the UE may determine to observe the SL RSSI within the time unit.

In an embodiment, in response to determining to observe the SL RSSI, the UE may determine “another linear average of total received power within the time unit” (denoted as linear average#3) as the SL RSSI. For instance, linear average#3 may be of:
(1) linear average#1;
(2) linear average#2;
(3) linear average of both linear average#1 and linear average#2; or
(4) linear average of total received power within the time unit, i.e., linear average of total received power observed in the whole time unit.

In an embodiment, linear average#3 is measured starting from “a symbol after a starting symbol of the time unit” or “a configured starting point after the starting symbol of the time unit”. Specific examples are described in the embodiments of FIGS. 4 and 5 as follows.

In some embodiments, the UE may determine whether at least one of a SCI transmission or a sequence transmission is transmitted within the time unit. In response to detecting the at least one of the SCI transmission or the sequence transmission transmitted within the time unit, the UE may determine to observe the SL RSSI within the time unit. In an embodiment, in response to determining to observe the SL RSSI, the UE may measure “linear average of total received power in a frequency domain resource within the time unit” as the SL RSSI. For instance, the frequency domain resource includes at least one of: one or more sub-channels; one or more interlaces; one or more RB sets; or a measurement bandwidth. A specific example is described in Embodiment 2 as follows.

In some embodiments, configuration#1 includes at least one of:
(1) A further threshold (denoted as threshold#2) related to linear average of total received power sensed over a CBR measurement window for the sidelink on the unlicensed band. For example, threshold#2 is a (pre-)configured threshold used over a CBR measurement window [n-a, n-1] as shown in FIG. 3.
(2) A default value of a sidelink CBR measurement value for the sidelink on the unlicensed band, e.g., DefaultCBR-SL-U.
(3) A minimum total number of RSSI measurement time units for the sidelink on the unlicensed band, e.g., MinNumRssiMeasurementTime Units-SL-U.

In some embodiments, to determine whether to observe the SL RSSI, the UE may receive information regarding WLAN RSSI measurement time units within a CBR measurement window, and may determine whether there is a SL RSSI measurement time unit by excluding the WLAN RSSI measurement time units from RSSI measurement time units within the CBR measurement window. A specific example is described in Embodiment 1 as follows.

In some embodiments, the UE may determine whether a total number of SL RSSI measurement time units within the CBR measurement window is less than “the minimum total number”, wherein linear average of total received power of a SL RSSI within each of the SL RSSI measurement time units exceeds threshold#2. In response to that the total number is less than the minimum total number, the UE may set the total number as the default value. A specific example is described in the embodiments of FIG. 3 as follows.

Details described in all of the foregoing embodiments of the present disclosure are applicable for the embodiments shown in FIG. 2. It should be appreciated by persons skilled in the art that the sequence of the operations in exemplary procedure 200 may be changed and some of the operations in exemplary procedure 200 may be eliminated or modified, without departing from the spirit and scope of the disclosure.

Some other embodiments of the present application provide an exemplary procedure performed by a network node, e.g., BS 101 as shown in FIG. 1. Although described with respect to a network node, it should be understood that other devices may be configured to perform a similar method. In this exemplary procedure, the network node may transmit a configuration (denoted as configuration#1) configured for a sidelink on an unlicensed band to a UE.

Configuration#1 may include a threshold (denoted as threshold#1) related to linear average of total received power within a time unit. The time unit may be one of: a slot, a mini-slot, and a sub-slot. In response to that a difference between “a linear average of total received power observed in a frequency domain resource (denoted as frequency domain resource#1) and a time domain resource (denoted as time domain resource#1) within the time unit” and “a linear average of total received power observed in frequency domain resource#1 and a further time domain resource (denoted as time domain resource#2) within the time unit” is equal to or less than threshold#1, the SL RSSI is determined by the UE to be observed within the time unit.

In some embodiments, threshold#1 is of a fixed value, a configured value, or a pre-configured value. In some embodiments, threshold#1 may be configured or pre-configured per SCS and/or per a resource pool.

In some embodiments, frequency domain resource#1 includes at least one of: one or more sub-channels; one or more interlaces; one or more RB sets; or a measurement bandwidth.

In an embodiment, time domain resource#1 includes one or more symbols after a starting symbol of the time unit and before time domain resource#2 within the time unit; and time domain resource#2 includes one or more symbols after time domain resource#1 and before an ending symbol of the time unit.

In an embodiment, configuration#1 includes at least one of:
(1) a further threshold (denoted as threshold#2) related to linear average of total received power sensed over a CBR measurement window for the sidelink on the unlicensed band;
(2) a default value of a sidelink CBR measurement value for the sidelink on the unlicensed band, e.g., DefaultCBR-SL-U; or
(3) a minimum total number of RSSI measurement time units for the sidelink on the unlicensed band, e.g., MinNumRssiMeasurementTime Units-SL-U.

In some embodiments, in response to that “a total number of SL RSSI measurement time units within the CBR measurement window” is less than the minimum total number, the total number is set by the UE as the default value.

The following texts describe specific embodiments of the exemplary procedure 200 as shown in FIG. 2 or the abovementioned exemplary procedure performed by a network node.

In general, for an unlicensed band, if a channel is accessed by 3GPP system for a slot or mini-slot or sub-slot transmission based on a listen-before-talk (LBT) result (i.e., LBT success), the sidelink transmission will start from the slot or mini-slot or sub-slot boundary. But for the other system or RAT, after channel access procedure, if LBT success, the transmission is not slot or mini-slot or sub-slot based, i.e., the other system's transmission or the other RAT's transmission can be started from each symbol from 3GPP system point of view. So, within a slot or mini-slot or sub-slot, measured linear average of the total received power on each symbol may be different.

Based on above, “to measure the linear average of the total received power for the subsequent first symbol and the other symbols separately” can help to distinguish the 3GPP system and other system or RAT within the slot or mini-slot or sub-slot.

FIG. 3 illustrates an exemplary diagram of SL RSSI measurement in a CBR measurement window in accordance with some embodiments of the present disclosure. In the embodiments of FIG. 3. DefaultCBR-SL-U and MinNumRssiMeasurementTime Units-SL-U may be configured for SL-U.
(1) DefaultCBR-SL-U: higher layer(s) indicates or (pre-)configures a default value of SL CBR measurement value for a UE that is configured to perform transmission on the unlicensed band if the total number of SL RSSI measurement time units over a CBR measurement window is below MinNumRssiMeasurementTime Units-SL-U. That is, the number of SL RSSI measurement time units within the CBR measurement window is below a (pre-)configured threshold.
(2) MinNumRssiMeasurementTimeUnits-SL-U: higher layer(s) indicates or (pre-)configures a threshold for a minimum number of SL RSSI measurement time units over a CBR measurement window for which the SL RSSI is measured for a UE that is configured to perform transmission on the unlicensed band.

In different embodiments of the present disclosure, MinNumRssiMeasurementTime Units-SL-U may be named as MinNumRssiMeasurementSlots-SL-U, MinNumRssiMeasurementMiniSlots-SL-U, MinNumRssiMeasurementSubSlots-SL-U, or the like.

As shown in FIG. 3, a CBR measurement window is [n-a, n-1] in time domain, wherein a is equal to 100 or 100·2^{μ} time units, according to higher layer parameter sl-Time WindowSizeCBR. That is, the CBR measurement window is before “time unit n”, starts from “time unit n-a”, and ends at “time unit n-1”. The CBR measurement window may include SL RSSI measurement time unit(s) and/or WLAN RSSI measurement time unit(s). The measurement time unit may be a slot, a mini-slot, or a sub-slot.

In some embodiments of FIG. 3, SL CBR measured in “time unit n” is defined as the portion of sub-channels in the resource pool whose SL RSSI measured by the UE exceeds a (pre-)configured threshold (e.g., threshold#2) sensed over a CBR measurement window [n-a, n-1]. When the UE is configured to perform partial sensing by higher layer(s) (including when SL DRX is configured), SL RSSI is measured in time units where the UE performs partial sensing and where the UE performs PSCCH or PSSCH reception within the CBR measurement window. The calculation of SL CBR is limited within the time units for which the SL RSSI is measured. If the total number of SL RSSI measurement time units within the CBR measurement window is below a (pre-)configured threshold, a (pre-)configured SL CBR value is used, e.g., DefaultCBR-SL-U.

In an embodiment of FIG. 3 (denoted as Embodiment 1 for simplicity), a total number of SL RSSI measurement time unit(s) may be calculated as below. A UE receives WLAN RSSI for a time unit from higher layer(s), and the UE observes SL-RSSI measurement value per time unit within CRB measurement window. The UE may exclude time unit(s) on which WLAN RSSI is provided, and then, the UE may perform CBR calculation based on the time unit(s) where observed SL-RSSI exceed a (pre-)configured threshold (e.g., threshold#2).

For example, as shown in FIG. 3, within the CBR measurement window, WLAN RSSI is provided in five WLAN RSSI measurement time units, and three SL RSSI measurement time units are lower than the power threshold (e.g., threshold#2). In case that a total number of “SL RSSI measurement time units not lower than the power threshold within the CBR measurement window” is less than MinNumRssiMeasurementTime Units-SL-U, the SL CBR measurement value for the UE is set as the default value, i.e., DefaultCBR-SL-U. In case that the total number of “SL RSSI measurement time units not less than the power threshold within the CBR measurement window” is not less than MinNumRssiMeasurementTime Units-SL-U, the actual total number of SL RSSI measurement time units is determined as the SL CBR measurement value for the UE.

FIG. 4 illustrates an exemplary flowchart of SL RSSI measurement in accordance with some embodiments of the present disclosure. The embodiments of FIG. 4 refer to solutions of SL RSSI measurement to distinguish 3GPP and other RAT for slot based SL-U. A time unit in the embodiments of FIG. 4 is a slot in time domain. Details described in all of the foregoing embodiments of the present disclosure are applicable for the embodiments shown in FIG. 4.

FIG. 4 shows frequency domain resource (i.e., frequency domain resource#1) in one slot in time domain, and the slot includes 14 symbols, i.e., symbol#0 to symbol#13. Symbol#0 is automatic gain control (AGC) symbol. Symbol#13 is guard period (GP) symbol. For sidelink communication on an unlicensed band, i.e., SL-U, SL RSSI is defined as the linear average of the total received power (in [W]) observed in frequency domain resource#1 and time domain resource#1 and time domain resource#2. In particular:
(1) Frequency domain resource#1 can be (pre-)configured sub-channel(s) or interlace(s) or RB set(s) or measurement bandwidth.
(2) Time domain resource#1 can be “one or more symbols starting from a starting symbol for PSCCH and PSSCH transmission” before time domain resource#2 within a slot. For instance, the starting symbol of time domain resource#1 is symbol#1 as shown in FIG. 4. The length of time domain resource#1 and/or the ending symbol of time domain resource#1 can be (per-)configured.
(3) Time domain resource#2 can be one or more symbols after time domain resource#1 within the slot. For instance, the ending symbol of time domain resource#2 is the last symbol for PSCCH and PSSCH transmission, e.g., symbol#12 as shown in FIG. 4. The length of time domain resource#2 and/or the starting symbol of time domain resource#2 can be (per-)configured.

In some embodiments, frequency domain resource#1, a total number of symbol(s) in time domain resource#1 and/or time domain resource#2 can be (pre-)configured by higher layer signalling. In some other embodiments, a total number of symbol(s) in time domain resource#1 and/or time domain resource#2 can be associated with the SCS, for example, 1 symbol for 15 kHz SCS, 2 symbols for 30 kHz SCS, 3 symbols or 4 symbols for 60 kHz SCS.

In some embodiments of FIG. 4, linear average#1 of the total received power (in [W]) is observed in frequency domain resource#1 and time domain resource#1. Linear average#2 of the total received power (in [W]) is observed in frequency domain resource#1 and time domain resource#2.

If linear average#1 of the total received power (in [W]) is equal to linear average#2 of the total received power (in [W]), or if “the difference between linear average#1 of the total received power (in [W]) and linear average#2 of the total received power (in [W])” is less than a fixed or a (per-)configured difference or offset value (e.g., threshold#1), SL RSSI may be defined as the linear average of the total received power (in [W]) observed in frequency domain resource#1 and time domain resource #1, and/or observed in frequency domain resource#1 and time domain resource#2. That is, SL RSSI may be defined as linear average#1 of the total received power, or linear average#2 of the total received power, or “linear average of linear average#1 of the total received power and linear average#2 of the total received power”.

Then, the UE may calculate or determine the SL CBR measurement value within a CBR measurement window for the UE based on DefaultCBR-SL-U and MinNumRssiMeasurementTime Units-SL-U in accordance with the embodiments of FIG. 3.

In some embodiments of FIG. 4, higher layer(s) may indicate a (per-)configured total number of symbols for time domain resource#1 and/or time domain resource#2. In some embodiments of FIG. 4, higher layer(s) may indicate a (per-)configured difference or offset value (e.g., threshold#1) for determining “the difference between linear average#1 of the total received power (in [W]) and linear average#2 of the total received power (in [W])”.

FIG. 5 illustrates another exemplary flowchart of SL RSSI measurement in accordance with some embodiments of the present disclosure. The embodiments of FIG. 5 refer to solutions of SL RSSI measurement to distinguish 3GPP and other RAT for mini-slot or sub-slot based SL-U. A time unit in the embodiments of FIG. 5 is a mini-slot or a sub-slot in time domain. Details described in all of the foregoing embodiments of the present disclosure are applicable for the embodiments shown in FIG. 5.

For instance, FIG. 5 shows frequency domain resource (i.e., frequency domain resource#1) in two mini-slots in time domain, which may also be named as two sub-slots. For example, one mini-slot includes 7 symbols, i.e., symbol#0 to symbol#6. Symbol#0 is AGC symbol. Symbol#6 is GP symbol. The other mini-slot also includes 7 symbols, i.e., symbol#7 to symbol #13. Symbol#7 is AGC symbol. Symbol#13 is GP symbol. It should be appreciated by persons skilled in the art that a total number of mini-slots or sub-slots within one time slot and/or a total number of symbols in a mini-slot or a sub-slot may be changed or configured to be different in different embodiments, without departing from the spirit and scope of the disclosure.

In the embodiments of FIG. 5, for sidelink communication on an unlicensed band, i.e., SL-U, SL RSSI in each mini-slot is defined as the linear average of the total received power (in [W]) observed in frequency domain resource#1 and time domain resource#1 and time domain resource#2. Similar to the embodiments of FIG. 4, frequency domain resource#1, time domain resource#1, and time domain resource#1 in the embodiments of FIG. 5 have definitions as below, and the differences are that the time unit in the embodiments of FIG. 5 is a mini-slot or a sub-slot.
(1) Frequency domain resource#1 can be (pre-)configured sub-channel(s) or interlace(s) or RB set(s) or measurement bandwidth.
(2) Time domain resource#1 can be “one or more symbols starting from a starting symbol for PSCCH and PSSCH transmission” before time domain resource#2 within a mini-slot or a sub-slot. For instance, the starting symbol of time domain resource#1 is symbol#1 as shown in FIG. 5. The length of time domain resource#1 and/or the ending symbol of time domain resource#1 can be (per-)configured.
(3) Time domain resource#2 can be one or more symbols after time domain resource#1 within the mini-slot or the sub-slot. For instance, the ending symbol of time domain resource#2 is the last symbol for PSCCH and PSSCH transmission, e.g., symbol#12 as shown in FIG. 5. The length of time domain resource#2 and/or the starting symbol of time domain resource#2 can be (per-)configured.

In the specific embodiment as shown in FIG. 5, in one mini-slot including symbol#0 to symbol#6, time domain resource#1 includes symbol#1, and time domain resource#2 includes symbol#2 to symbol#5. In the other mini-slot including symbol#7 to symbol#13, time domain resource#1 includes symbol#8, and time domain resource#2 includes symbol#9 to symbol#12. In other words, besides the starting symbol within a slot for the PSCCH and PSSCH transmission at symbol#0 (i.e., for the one mini-slot), additional starting symbol(s) is/are (pre-)configured for SL-U at symbol#7 (i.e., for the other mini-slot). For example, as shown in FIG. 5, the SL RSSI measurement starts from the 2^{nd} OFDM symbol (i.e., symbol#1) for the one mini-slot, and the SL RSSI measurement starts from the 9th OFDM symbol (i.e., symbol#8) for the other mini-slot.

In other specific embodiment as shown in FIG. 5, the total number of symbols in time domain resource#1 and time domain resource#2 in each mini-slot or sub-slot may be differently configured, without departing from the spirit and scope of the disclosure.

In the abovementioned specific embodiment as shown in FIG. 5, linear average#1 of the total received power (in [W]) is observed in frequency domain resource#1 and time domain resource#1, e.g., symbol#1 as shown in FIG. 5 for the one mini-slot measurement, or symbol#8 as shown in FIG. 5 for the other mini-slot measurement.

Linear average#2 of the total received power (in [W]) is observed in frequency domain resource#1 and time domain resource#2, e.g., symbol#2 to symbol#5 as shown in FIG. 5 for the one mini-slot measurement, or symbol#9 to symbol#12 as shown in FIG. 5 for the other mini-slot measurement.

In each mini-slot in FIG. 5, if linear average#1 of the total received power (in [W]) is equal to linear average#2 of the total received power (in [W]), or if “the difference between linear average#1 of the total received power (in [W]) and linear average#2 of the total received power (in [W])” is less than a fixed or a (per-)configured difference or offset value (e.g., threshold#1), SL RSSI in the mini-slot may be defined as the linear average of the total received power (in [W]) observed in frequency domain resource#1 and time domain resource#1, and/or observed in frequency domain resource#1 and time domain resource#2. That is, SL RSSI in the mini-slot may be defined as linear average#1 of the total received power, or linear average#2 of the total received power, or “linear average of linear average#1 of the total received power and linear average#2 of the total received power”.

Then, the UE may calculate or determine the SL CBR measurement value for each mini-slot or sub-slot within a CBR measurement window for the UE based on DefaultCBR-SL-U and MinNumRssiMeasurementTime Units-SL-U in accordance with the embodiments of FIG. 3.

In some embodiments of FIG. 5, higher layer(s) may indicate a (per-)configured total number of symbols for time domain resource#1 and/or time domain resource#2 in a mini-slot or a sub-slot. In some embodiments of FIG. 5, higher layer(s) may indicate a (per-)configured difference or offset value (e.g., threshold#1) for determining “the difference between linear average#1 of the total received power (in [W]) and linear average#2 of the total received power (in [W])”.

The following texts describe specific Embodiment 2 of the exemplary procedure 200 as shown in FIG. 2 or the abovementioned exemplary procedures performed by a UE. The UE may be UE 102 as shown and illustrated in FIG. 1.

In Embodiment 2, SCI and/or a sequence transmission is decoded to distinguish 3GPP system and other RAT. In particular, the UE may detect the potential SCI transmission and/or a sequence transmission, e.g., DMRS, to determine whether there is a sidelink transmission performed at the slot boundary, the mini-slot boundary, or the sub-slot boundary.

For example, for one starting point case (e.g., one starting point of a slot as shown in FIG. 4), if any SCI transmission and/or sequence transmission is detected, SL RSSI is defined as the linear average of the total received power (in [W]) observed in the configured sub-channel(s) or interlace(s) or RB set(s) or measurement bandwidth of the slot, the mini-slot, or the sub-slot configured for PSCCH and PSSCH, starting from the 2^{nd} OFDM symbol or starting from additional configured starting point for PSCCH and PSSCH after AGC symbol (i.e., symbol#1). Then, the UE may calculate or determine the SL CBR measurement value for each mini-slot within a CBR measurement window for the UE based on DefaultCBR-SL-U and MinNumRssiMeasurementTime Units-SL-U in accordance with the embodiments of FIG. 3.

For two starting point case (e.g., two starting points of two mini-slots as shown in FIG. 5), if any SCI transmission and/or sequence transmission is detected, besides the 2^{nd} OFDM symbol for PSCCH and PSSCH transmission, an additional starting point for the AGC/PSCCH/PSSCH transmission (e.g., for the other mini-slot) is symbol#7, and the SL RSSI may be observed from the 8^{th} OFDM symbol as shown in FIG. 5. Then, the UE may calculate or determine the SL CBR measurement value for each mini-slot within a CBR measurement window for the UE based on DefaultCBR-SL-U and MinNumRssiMeasurementTimeUnits-SL-U in accordance with the embodiments of FIG. 3.

FIG. 6 illustrates a block diagram of an exemplary apparatus 600 in accordance with some embodiments of the present application. As shown in FIG. 6, the apparatus 600 may include at least one processor 606 and at least one transceiver 602 coupled to the processor 606. Although in this figure, elements such as the at least one transceiver 602 and processor 606 are described in the singular, the plural is contemplated unless a limitation to the singular is explicitly stated. In some embodiments of the subject application, the transceiver 602 may be divided into two devices, such as a receiving circuitry and a transmitting circuitry. In some embodiments of the subject application, the apparatus 600 may further include an input device, a memory, and/or other components.

In some embodiments of the subject application, the apparatus 600 may be a UE or a network node (e.g., a BS). The transceiver 602 and the processor 606 may interact with each other so as to perform the operations with respect to the UE or the network node described above, for example, in any of FIGS. 1-5.

In some embodiments of the subject application, the apparatus 600 may further include at least one non-transitory computer-readable medium. For example, in some embodiments of the present disclosure, the non-transitory computer-readable medium may have stored thereon computer-executable instructions to cause the processor 606 to implement the method with respect to a UE or a network node (e.g., a BS) as described above. For example, the computer-executable instructions, when executed, cause the processor 606 interacting with transceiver 602 to perform the operations with respect to the UE or the network node described in FIGS. 1-5.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including”. Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the subject application, but is not used to limit the substance of the subject application.

1. A user equipment (UE) for wireless communication, comprising:
at least one memory; and
at least one processor coupled with the at least one processor and configured to cause the UE to:
receive:
a configuration from a network node, wherein the configuration includes a first threshold related to linear average of total received power within a time unit, and wherein the time unit is one of: a slot, a mini-slot, and a sub-slot; or
a sidelink control information (SCI) transmission within the time unit on a sidelink on an unlicensed band; and
determine whether to observe a sidelink received signal strength indicator (SL RSSI) within the time unit for the sidelink on the unlicensed band.

2. The UE of claim 1, wherein the at least one processor is further configured to cause the UE to:
measure first linear average of total received power observed in a first frequency domain resource and a first time domain resource within the time unit;
measure second linear average of total received power observed in the first frequency domain resource and a second time domain resource within the time unit;
determine whether a difference between the first linear average of total received power and the second linear average of total received power is equal to or less than the first threshold; and
in response to the difference being equal to or less than the first threshold, determine to observe the SL RSSI within the time unit.

3. The UE of claim 1, wherein the first threshold is of a fixed value, a configured value, or a pre-configured value.

4. The UE of claim 1, wherein the first threshold is configured or pre-configured per sub carrier spacing (SCS) or per a resource pool.

5. The UE of claim 2, wherein, in response to determining to observe the SL RSSI, the at least one processor is further configured to cause the UE to determine a third linear average of total received power within the time unit as the SL RSSI to be:
the first linear average of total received power; or
the second linear average of total received power.

6. The UE of claim 2, wherein:
the first time domain resource includes one or more symbols after a starting symbol of the time unit and before the second time domain resource within the time unit; and
the second time domain resource includes one or more symbols after the first time domain resource.

7. The UE of claim 1, wherein the at least one processor is further configured to cause the UE to:
determine whether a sidelink control information (SCI) transmission is transmitted within the time unit; and
in response to detecting the SCI transmission determine to observe the SL RSSI within the time unit.

8. The UE of claim 7, wherein, in response to determining to observe the SL RSSI, the at least one processor is further configured to cause the UE to measure a third linear average of total received power in a first frequency domain resource within the time unit as the SL RSSI.

9. The UE of claim 2, wherein the first frequency domain resource includes at least one of:
one or more sub-channels;
one or more interlaces;
one or more resource block (RB) sets; or a measurement bandwidth.

10. The UE of claim 2, wherein the first linear average of total received power or the second linear average of total received power is measured starting from:
a symbol after a starting symbol of the time unit; or
a configured starting point after the starting symbol of the time unit.

11. The UE of claim 1, wherein the configuration includes at least one of:
a second threshold related to linear average of total received power sensed per time unit over a channel busy ratio (CBR) measurement window for the sidelink on the unlicensed band;
a default value of a sidelink CBR measurement value for the sidelink on the unlicensed band; or
a minimum total number of RSSI measurement time units for the sidelink on the unlicensed band.

12. The UE of claim 1, wherein, to determine whether to observe the SL RSSI, the at least one processor is configured to cause the UE to:
receive information regarding wireless local area network (WLAN) RSSI measurement time units within a channel busy ratio (CBR) measurement window; and
determine whether there is an SL RSSI measurement time unit by excluding the WLAN RSSI measurement time units from RSSI measurement time units within the CBR measurement window.

13. The UE of claim 11, wherein the at least one processor is configured to cause the UE to:
determine whether a total number of SL RSSI measurement time units within the CBR measurement window is less than the minimum total number, wherein linear average of total received power of a SL RSSI within each of the SL RSSI measurement time units exceeds the second threshold; and
in response to the total number is less than the minimum total number, set the total number as the default value.

14. A network node for wireless communication, comprising:
at least one memory; and
at least one processor coupled with the at least one memory and configured to cause the network node to:
transmit a configuration configured for a sidelink on an unlicensed band to a user equipment (UE), wherein:
the configuration includes a first threshold related to linear average of total received power within a time unit,
wherein the time unit is one of: a slot, a mini-slot, and a sub-slot; and
in response to a difference between a first linear average of total received power observed in a first frequency domain resource and a first time domain resource within the time unit and a second linear average of total received power observed in the first frequency domain resource and a second time domain resource within the time unit being equal to or less than the first threshold, the SL RSSI is determined by the UE to be observed within the time unit.

15. (canceled)

16. A method performed by a user equipment (UE), the method comprising:
receiving:
a configuration from a network node, wherein the configuration includes a first threshold related to linear average of total received power within a time unit, and wherein the time unit is one of: a slot, a mini-slot, and a sub-slot; or
a sidelink control information (SCI) transmission within the time unit on a sidelink on an unlicensed band; and
determining whether to observe a sidelink received signal strength indicator (SL RSSI) within the time unit for the sidelink on the unlicensed band.

17. The method of claim 16, further comprising:
measuring first linear average of total received power observed in a first frequency domain resource and a first time domain resource within the time unit;
measuring second linear average of total received power observed in the first frequency domain resource and a second time domain resource within the time unit;
determining whether a difference between the first linear average of total received power and the second linear average of total received power is equal to or less than the first threshold; and
in response to the difference being equal to or less than the first threshold, determining to observe the SL RSSI within the time unit.

18. The method of claim 17, further comprising: determining, in response to determining to observe the SL RSSI, a third linear average of total received power within the time unit as the SL RSSI to be:
the first linear average of total received power; or
the second linear average of total received power.

19. The method of claim 17, wherein:
the first time domain resource includes one or more symbols after a starting symbol of the time unit and before the second time domain resource within the time unit; and
the second time domain resource includes one or more symbols after the first time domain resource.

20. The method of claim 17, wherein the first linear average of total received power or the second linear average of total received power is measured starting from:
a symbol after a starting symbol of the time unit; or
a configured starting point after the starting symbol of the time unit.

21. The method of claim 16, further comprising:
determining whether a sidelink control information (SCI) transmission is transmitted within the time unit; and
in response to detecting the SCI transmission, determining to observe the SL RSSI within the time unit.
